(19) United States
(12) Patent Application Publication
(10) Pub. No.: US 2018/0039677 A1
(43) Pub. Date: Feb. 8, 2018

(54) DATA SEARCHING APPARATUS

(71) Applicant: Jin Hyuk Choi, Daejeon (KR)

(72) Inventor: Jin Hyuk Choi, Daejeon (KR)

(73) Assignee: INFORIENCE INC., Daejeon (KR)

(21) Appl. No.: 15/347,718

(22) Filed: Nov. 9, 2016

(30) Foreign Application Priority Data
Aug. 4, 2016 (KR) 10-2016-0099312

(51) Int. Cl. G06F 17/30

(52) U.S. Cl. CPC G06F 17/30551; G06F 17/30312; G06F 17/3053

(57) ABSTRACT

The present disclosure relates to a data searching apparatus. The data searching apparatus includes: a memory configured to store time-series data formed of a plurality of segments including a first segment and a second segment; and a processor configured to read out the time-series data by accessing the memory, wherein the processor derives a first matching segment of search target time-series data matched to the first segment, and counts the number of times of matching when a second matching segment of the search target time-series data matched to the second segment is derived from the first matching segment within a set time.

### CROSS-REFERENCE TO RELATED APPLICATIONS

This application claims priority under 35 U.S.C. §119 from Korean Application No. 10-2016-0099312 filed on Aug. 4, 2016, the subject matter of which is incorporated herein by reference.

### BACKGROUND OF THE INVENTION

### Field of the Invention

The present disclosure relates to a data searching apparatus.

### Description of the Related Art

Since anybody may collect data through a web, a smart phone, an IoT sensor, and the like, the diversification and personalization of data source has been achieved. In order to support this trend, data analysis algorithm has been used in the form of open-source and platform has been formed to provide service. In addition, it is possible to apply algorithm even in the case of not having a specialized technical knowledge.

However, even if data and algorithm are prepared, not everyone may easily utilize the data. Technical knowledge and experience are required to process the data, search key information included in the data, and apply data mining or machine learning algorithm, but not everyone has such knowledge and experience.

In addition, in the future, as much as expert knowledge on the data or the algorithm, the importance of the experiential knowledge on the environment and condition in which data is generated, the personal disposition, and the knowhow for the data utilized by applying specific parameter for specific algorithm would be even greater.

In addition to the data, it is a very important factor in implementing an artificial intelligence service to perform the process for collecting the data on a large scale.

Therefore, everyone should be able to easily borrow the ability of an experienced hand having an empirical knowledge on the data or an expert having a professional skill on the data analysis so that everyone may be able to take advantage of their own data maximally. On the other hand, it is necessary that experienced hands and experts may have the opportunity to generate revenue by utilizing their knowledge and experience through such a process.

### SUMMARY OF THE INVENTION

The present disclosure has been made in view of the above problems, and provides a data searching apparatus to calculate correlation of different time-series data.

The present disclosure further provides a data searching apparatus to automatically derive the correlation.

In accordance with an aspect of the present disclosure, a data searching apparatus includes: a memory configured to store time-series data formed of a plurality of segments including a first segment and a second segment; and a processor configured to read out the time-series data by accessing the memory, wherein the processor derives a first matching segment of search target time-series data matched to the first segment, and counts the number of times of matching when a second matching segment of the search target time-series data matched to the second segment is derived from the first matching segment within a set time.

In accordance with another aspect of the present disclosure, a data searching apparatus includes: a memory configured to store a first time-series data formed of a plurality of segments including a first segment and a second time-series data formed of a plurality of segments including a second segment; and a processor configured to read out the first time-series data and the second time-series data by accessing the memory, wherein the processor derives a first matching segment of a first search target time-series data matched to the first segment, and counts the number of times of matching when a second matching segment of a second search target time-series data matched to the second segment is derived from the first matching segment within a set time.

The processor derives test matching segment of test search target time-series data matched to test segment of test time-series data, and selects a first test segment and a second test segment which have a high importance among a plurality of the test segments as the first segment and the second segment respectively according to the derivation result. The processor derives a first test matching segment of a first test search target time-series data which is matched to a first test segment of a first test time-series data, selects a first test segment having a high importance among a plurality of the first test segments as the first segment according to the derivation result of the first test matching segment, derives a second test matching segment of a second test search target time-series data which is matched to a second test segment of a second test time-series data, and selects a second test segment having a high importance among a plurality of the second test segments as the second segment according to the derivation result of the second test matching segment. The processor derives the test matching segment while changing permission similarity between the test segment and the test matching segment. The processor derives the first test matching segment and the second test matching segment while changing a first permission similarity between the first test segment and the first test matching segment, and a second permission similarity between the second test segment and the second test matching segment. The processor calculates the importance through at least one of the number of times of derivation of deriving the test matching segment in an entire section of the test search target time-series data, a sum of the test matching segment section, a ratio of the number of times of derivation and the test matching segment section, a ratio of the sum of the test matching segment section and the entire section, and a derivation cycle of the test matching segment. The processor calculates the importance of the first test segment through at least one of the number of times of a first derivation of deriving the first test matching segment in an entire section of the first test search target time-series data, a sum of the first test matching segment section, a ratio of the number of times of the first derivation and the first test matching segment section, a ratio of the sum of the first test matching segment section and the entire section of the first test search target time-series data, and a derivation cycle of the first test matching segment, and calculates the importance of the second test segment through at least one of the number of times of a second derivation of deriving the second test matching segment in an entire section of the second test search target time-series data, a sum of the second test matching segment section, a ratio of the number of times of the second derivation and the second test matching segment section, a ratio of the sum of the second test matching segment section and the entire section of the second test search target time-series data, and a derivation cycle of the second test matching segment. The processor calculates at least one of a ratio of the number of times of a derivation of deriving the first matching segment in the search target time-series data and the number of times of matching, and a ratio of the number of times of a derivation of deriving the second matching segment in the search target time-series data and the number of times of matching. The processor calculates at least one of a ratio of the number of times of a derivation of deriving the first matching segment in the first search target time-series data and the number of times of matching, and a ratio of the number of times of a derivation of deriving the second matching segment in the second search target time-series data and the number of times of matching. The processor calculates at least one ratio for the search target time-series data while automatically increasing the set time. The processor calculates at least one ratio for the first search target time-series data and the second search target time-series data while automatically increasing the set time. The processor assigns comment of a first user for the first segment and the second segment or a first segment section and a second segment section, and assigns a score of a second user for at least one of the first segment and the second segment, the first segment section and the second segment section, and the comment. The processor assigns comment of a first user for the first segment and the second segment or a first segment section and a second segment section, and assigns a score for comment of a second user cited in the comment of the first user.

### BRIEF DESCRIPTION OF THE DRAWINGS

The objects, features and advantages of the present disclosure will be more apparent from the following detailed description in conjunction with the accompanying drawings, in which:

FIG. 1 illustrates a data searching apparatus according to an embodiment of the present disclosure;

FIG. 2 and FIG. 3 illustrate an operation of a data searching apparatus for time-series data according to an embodiment of the present disclosure;

FIG. 4 and FIG. 5 illustrate an operation of a data searching apparatus for a first time-series data and a second time-series data according to an embodiment of the present disclosure;

FIG. 6 is a diagram illustrating a segmentation error value;

FIG. 7 is a diagram illustrating a selection of a first segment and a second segment through the importance of test segment; and

FIG. 8 is a diagram illustrating a selection of a first segment and a second segment through the importance of a first segment and a second segment.

### DETAILED DESCRIPTION OF EXEMPLARY EMBODIMENTS

Exemplary embodiments of the present disclosure are described with reference to the accompanying drawings in detail. The same reference numbers are used throughout the drawings to refer to the same or like parts. Detailed descriptions of well-known functions and structures incorporated herein may be omitted to avoid obscuring the subject matter of the present disclosure.

The terms and words used in the following description and claims are not limited to the bibliographical meanings, but, are merely used by the inventor to enable a clear and consistent understanding of the present disclosure. It is to be understood that the singular forms “a,” “an,” and “the” include plural referents unless the context clearly dictates otherwise.

In the present disclosure, the terms such as “include” and/or “have” may be construed to denote a certain feature, number, step, operation, constituent element, component or a combination thereof, but may not be construed to exclude the existence of or a possibility of addition of one or more other features, numbers, steps, operations, constituent elements, components or combinations thereof.

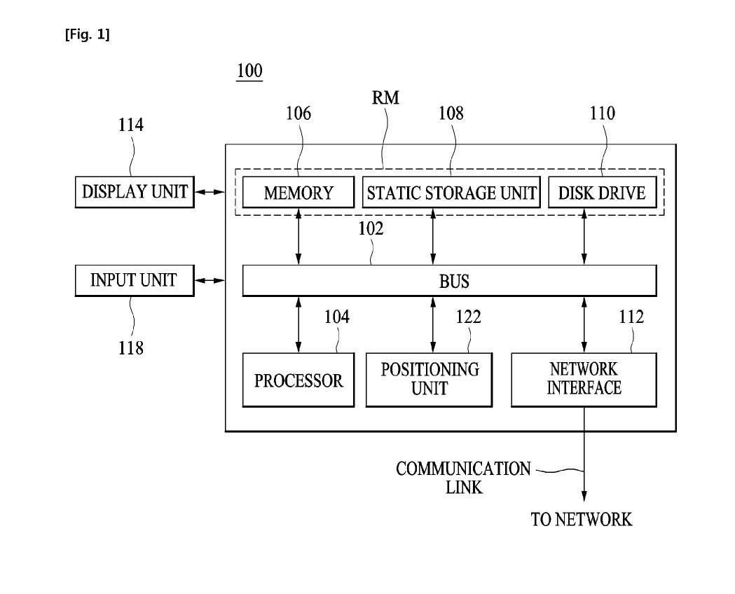

FIG. 1 illustrates a data searching apparatus according to an embodiment of the present disclosure. Referring to FIG. 1, the data searching apparatus according to an embodiment of the present disclosure may include a memory 106 and a processor 104.

The data searching apparatus according to an embodiment of the present disclosure may include a bus 102 or other communication mechanism for communicating information. Such a bus 102 or other communication mechanism may interconnect the processor 104, a computer readable recording medium (RM), a network interface 112 (e.g., a modem or an ethernet card), a display unit 114 (e.g., a CRT or a LCD), an input unit 118 (e.g., a keyboard, a keypad, a virtual keyboard, a mouse, a trackball, a stylus, a touch sensing means, etc.), and/or subsystems.

The computer-readable recording medium (RM) may include a memory 106 (e.g., RAM), a static storage unit 108 (e.g., ROM), a disk drive 110 (e.g., HDD, SSD, an optical disk, a flash memory drive, etc.), but it is not limited thereto. At this time, the disk drive may be a non-transitory recording medium. The optical disc may be CD, DVD, Blu-ray disc, but it is not limited thereto.

The data searching apparatus according to an embodiment of the present disclosure may include one or more disk drives 110. Further, as shown in FIG. 1, together with the processor 104, the disk drive 110 may be provided to a housing 120.

However, alternatively, it may be installed remotely to perform a remote communication with the processor 104. In addition, a database having one or more disk drives may be included.

The recording medium (RM) may store an operating system, a driver, an application program, a data, and a database required for the operation of the data searching apparatus according to an embodiment of the present disclosure.

The display unit 114 may display operation of the data searching apparatus according to an embodiment of the present disclosure and a user interface.

The processor 104 may be a CPU, a microcontroller, a digital signal processor (DSP), or the like, but it is not limited thereto, and may control the operation of the data searching apparatus according to an embodiment of the present disclosure.

The processor 104 may access the recording medium (RM) and may perform data search, comment allocation, processing of classification tag, machine learning, etc. which are described later by executing one or more sequences of instructions or logic stored in the recording medium (RM).

These instructions may be read into the memory 106 from other computer readable medium such as the static storage unit 108 or the disk drive 110. In other embodiments, instead of the software instructions for implementing the present disclosure, a hard-wired circuitry embedded in hardware may be used in combination with software instructions.

Logic may be encoded in the computer readable recording medium (RM) which may refer to an arbitrary medium that participates in providing instructions to the processor 104. Such a recording medium (RM) may include a non-volatile recording media, a volatile recording medium, but may take many forms which are not limited thereto.

The processor 104 may display the operation of the data searching apparatus and the operation of user interface on the display unit 114 by communicating with a hardware controller for the display unit 114.

In one embodiment, the computer-readable recording medium (RM) may be a non-transient. In various embodiments, the non-volatile recording medium (RM) may include an optical or magnetic disk, e.g., a disk drive 110, and the volatile recording medium may include a dynamic recording medium such as a system memory 106. Transmission media including wires that include the bus 102 may include coaxial cables, copper wire, and optical fibers.

In one example, transmission media may take the form of the radio wave and the sound waves or light wave which is generated in infrared data communications.

Some common forms of the computer readable recording medium (RM) may include, for example, a floppy disk, a flexible disk, a hard disk, a magnetic tape, any other magnetic medium, CD-ROM, any other optical medium, punch cards, a paper tape, any other physical medium with patterns of holes, RAM, PROM, EPROM, FLASH-EPROM, any other memory chip or cartridge, and any other medium that is adapted to be read by a carrier wave or a computer.

In various embodiments of the present disclosure, the execution of instruction sequences for implementing the present disclosure may be performed by the data searching apparatus according to an embodiment of the present disclosure. In various other embodiments of the present disclosure, a plurality of computing devices 100 which are coupled to network (e.g., other wired or wireless networks including LAN, WLAN, PTSN and/or remote communications, mobile and cellular phone networks) by a communication link 124 may perform instruction sequences for implementing the present disclosure by cooperating with each other.

The data searching apparatus according to an embodiment of the present disclosure may transmit and receive instructions that include messages, data, information, and one or more programs (i.e., application code) via the communication link 124 and a network interface 112.

The network interface 112 may include a separate or integrated antenna for enabling transmission and reception via the communication link 124. The received program code may be executed by the processor 104 when it is received, and/or may be stored in the disk drive 110 or some other non-volatile storage so as to execute.

Next, the operation of the data searching apparatus according to an embodiment of the present disclosure is described with reference to the drawings.

In the data searching apparatus according to an embodiment of the present disclosure, the memory 106 may store time-series data (Data#) formed of a plurality of segments including a first segment and a second segment.

The processor 104 may perform segmentation on base time-series data by using a Piecewise Linear Segmentation method and generate the time-series data (Data#) formed of a segment of a straight line shape, and the segments may be connected to each other.

Such segmentation method is not limited to the Piecewise Linear Segmentation method, and various segmentation methods may be applied to the present disclosure.

The base time-series data may include information on various data values corresponding to time.

For example, the base time-series data may be information on a sensing value corresponding to an output time of sensor, or information on stock price for a specific company or stock market corresponding to time. At this time, the sensor may implement a Internet of Things (IoT) service, or may be provided in a plant or a manufactory, or the like but it is not limited thereto.

In addition, the base time-series data may be output respectively from a different sensor sensing the same factor (temperature, humidity, vibration, pulse rate, body temperature, stock price, etc.), and may be data related to a different factor (e.g., temperature of sea surface, moving route of storm, temperature, and growth amount, etc.). The processor 104 may access the memory 106 and read the time-series data (Data#).

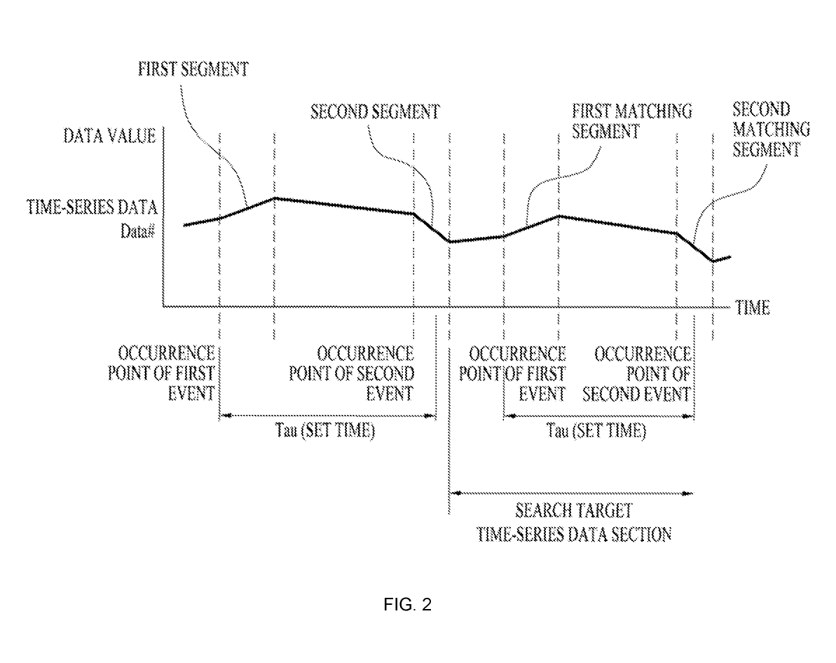

At this time, as shown in FIG. 2, the processor 104 may derive a first matching segment of search target time-series data (Data#_SER) matched to the first segment.

At this time, the search target time-series data (Data#_SER) also has been segmented by the processor 104.

In addition, the processor 104 may derive a second matching segment of search target time-series data (Data#_SER) matched to the second segment.

At this time, the processor 104 may count the number of times of matching when the second matching segment is derived from the first matching segment within a set time (Tau).

Time within a set time (Tau) may be time between the first segment and the second segment and may mean a time equal to or less than the set time (Tau). Since the time within a set time (Tau) is the time between the first segment and the second segment and may be a time between the first matching segment and the second matching segment.

At this time, the start point of the set time (Tau) may be a start point of the first segment. At this time, the start point of the first segment may be a first event occurrence time when the first segment starts.

The start point of the set time (Tau) is not limited to the start point of the first segment. That is, the start point of the set time (Tau) may exist within a section of the first segment.

In addition, the end point of the set time (Tau) may exist within a section of the second segment. Accordingly, the end point of the set time (Tau) may be a second event occurrence time when the second segment starts or a point after that time.

For example, the set time (Tau) may be a time from the middle point of the first segment to the middle point of the second segment.

The number of times of matching may be the number of times of matching in the entire section of search target time-series data (Data#_SER), and may be the number of times of matching in a preset partial section of search target time-series data (Data#_SER)

In addition, one more second matching segments may exist in the set time (Tau), and in this case, the number of matching may be counted as 1 and may be counted every second matching segment which exists during the set time (Tau).

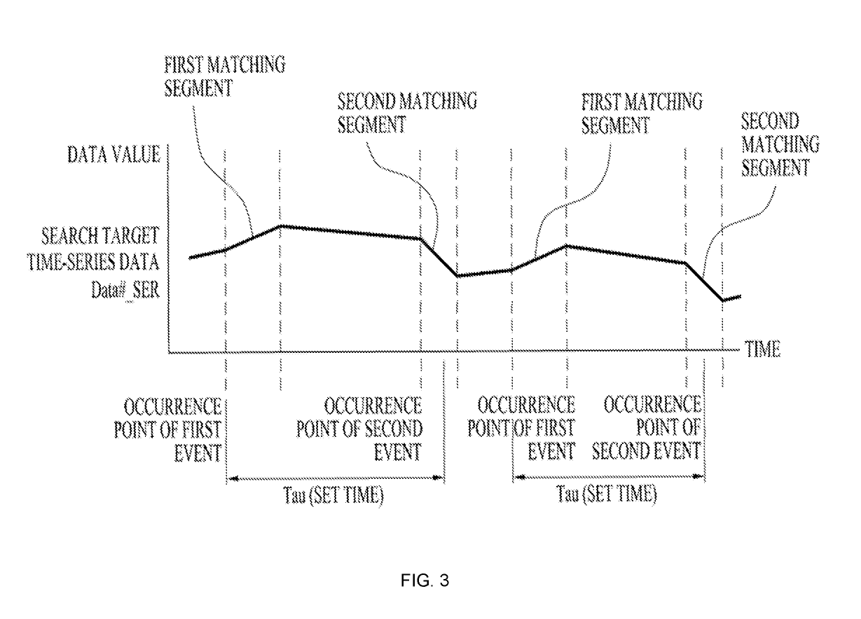

Meanwhile, as shown in FIG. 2, the search target time-series data (Data#_SER) may be a part of the time-series data (Data#), and may be time-series data different from the time-series data (Data#) as shown in FIG. 3.

Other search target time-series data (Data#_SER) different from the time-series data (Data#) may also be stored in the memory 106, and the processor 104 may read out the search target time-series data (Data#_SER).

The processor 104 may use the correlation method or the Euclidean Distance method in order to search the search target time-series data (Data#_SER) matched to the first and second segments, but various methods may be applied in addition to above methods.

For example, the processor 104 may derive a portion matched to a slope of each of the first segment and the second segment, the data value of the start point, and the data value of the end point from the search target time-series data (Data#_SER). Accordingly, the processor 104 may calculate the length of the first segment and the second segment together with the slope of the first segment and the second segment.

The processor 104 may derive the segment which has the same slope as the first and second segments, has the same slope or length, or has the same slope, length, and data value of the start point and the end point as the first matching segment and the second matching segment.

The processor 104 may perform matching of the first segment and the second segment while calculating according to a set permission similarity or increasing the permission similarity from a small value to a large value. The permission similarity may be a tolerance for determining a degree of congruence of the first segment and the second segment, and the search target time-series data (Data#_SER) which can be considered as matching.

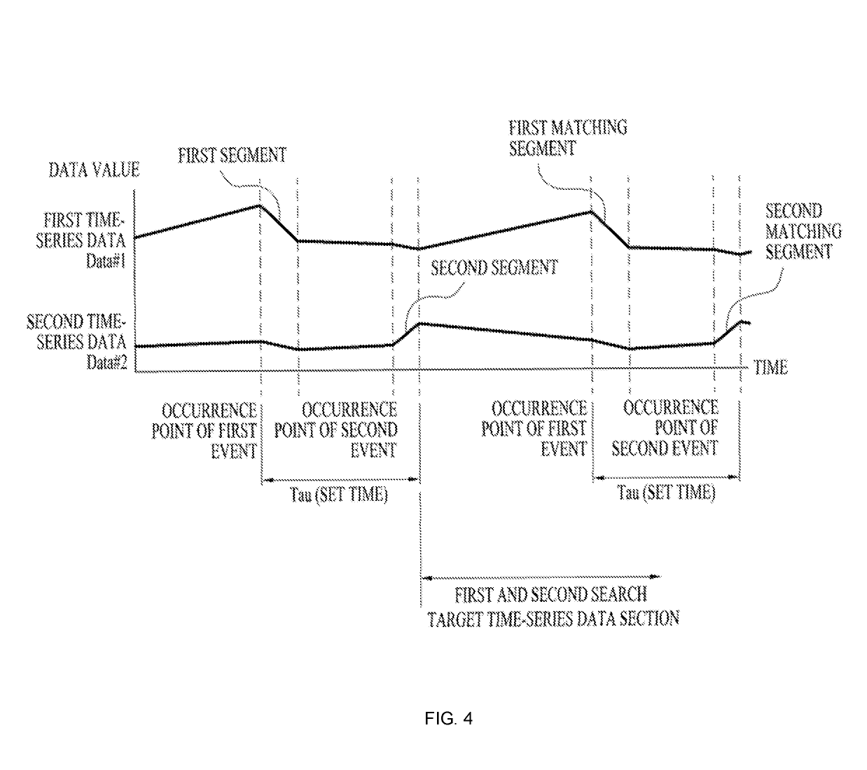

The data searching apparatus according to an embodiment of the present disclosure described above in FIG. 2 and FIG. 3 sets the first segment and the second segment in a single time-series data (Data#). However, alternatively, as shown in FIG. 4, the first segment and the second segment may be set in different time-series data Data#1 and Data#2.

That is, the memory 106 may store a first time-series data (Data#1) formed of a plurality of segments including the first segment and a second time-series data (Data#2) formed of a plurality of segments including the second segment. The processor 104 may access the memory 106 and read the first time-series data (Data#1) and the second time-series data (Data#2).

At this time, the processor 104 may derive the first matching segment of the first search target time-series data (Data#1_SER) matched to the first segment.

In addition, the processor 104 may derive the second matching segment of the second search target time-series data (Data#2_SER) matched to the second segment.

At this time, the processor 104 may count the number of times of matching when the second matching segment is derived from the first matching segment within the set time (Tau). Since the set time (Tau), the number of times of matching, the first segment, the second segment, the first matching segment, and the second matching segment are described above in detail through FIGS. 2 and 3, a description thereof is omitted.

The first time-series data (Data#1) and the second time-series data (Data#2) may be generated from different sensors, or may be related to different variables (e.g., temperature and humidity, heart rate and body temperature, etc.), but it is not limited thereto.

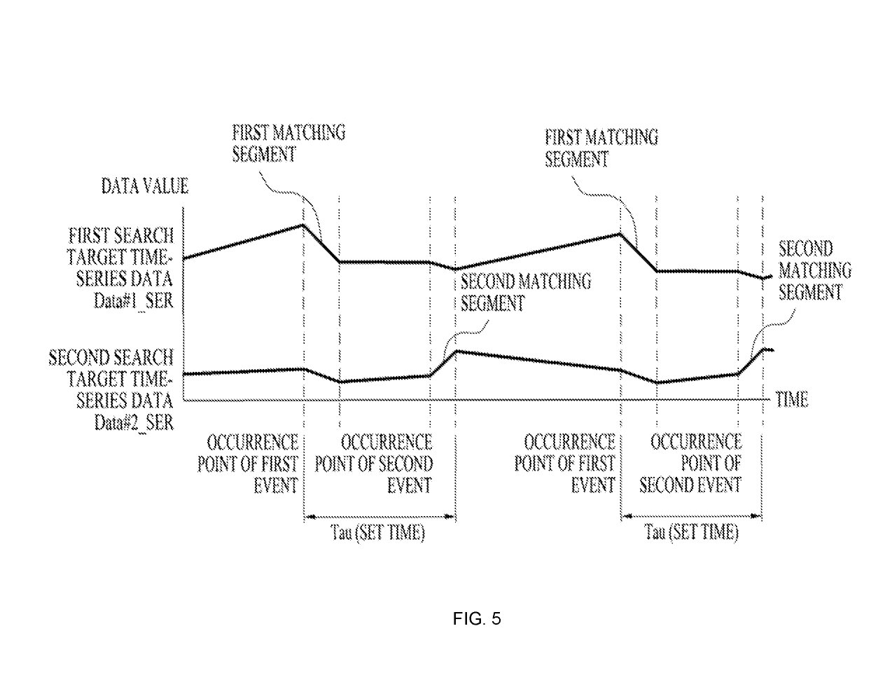

Meanwhile, the first search target time-series data (Data#1_SER) and the second search target time-series data (Data#2_SER) may be, as shown in FIG. 4, a part of the first time-series data (Data#1) and the second time-series data (Data#2), and may be, as shown in FIG. 5, time-series data different from Data#1 and Data#2.

Since the method of searching the first search target time-series data (Data#1_SER) and the second search target time-series data (Data#2_SER) matched to the first segment and the second segment by the processor 104, and the permission similarity are described above, a description thereof is omitted.

As described above through FIG. 2 to FIG. 5, the data searching apparatus according to an embodiment of the present disclosure may count the number of times of matching of the first segment and the second segment which are separated by the set time (Tau).

The first segment and the second segment which exist within the set time (Tau) may be selected automatically by the processor 104, and this selection may be related to a high correlation of the first segment and the second segment.

For example, when the first segment is a stock price of company A and the second segment is a stock price of company B, the correlation of the first segment and the second segment may be larger as the number of times of generating a second pattern in the stock price of company B within the set time (Tau) after the first segment is generated in the stock price of company A is increased.

Accordingly, the data searching apparatus according to an embodiment of the present disclosure may calculate and provide the number of times of matching of the first segment and the second segment in the search target time-series data (Data#_SER), thereby providing information on the correlation of the first segment and the second segment.

Meanwhile, the first segment and the second segment shown in FIGS. 2 and 3 may be selected from a plurality of test segments.

That is, the processor 104 may derive the test matching segment of test search target time-series data (TData#_SER) matched to the test segment of test time-series data (TData#).

The processor 104 may automatically select the first and second segments based on the importance of the test segment among the test segments, and this is described later in detail.

The selection of the test time-series data (TData#) may be achieved by a user or may be achieved by the processor 104.

The test time-series data (TData#) may be the same as the time-series data (Data#) or may be a different time-series data.

In addition, the test search target time-series data (TData#_SER) may also be the same as the search target time-series data (Data#_SER) or may be different.

At this time, the test segment may be set automatically by the processor 104. The processor 104 may automatically perform the segmentation on base test series data (TData#) with at least two error value respectively in a range of segmentation error of the test segment.

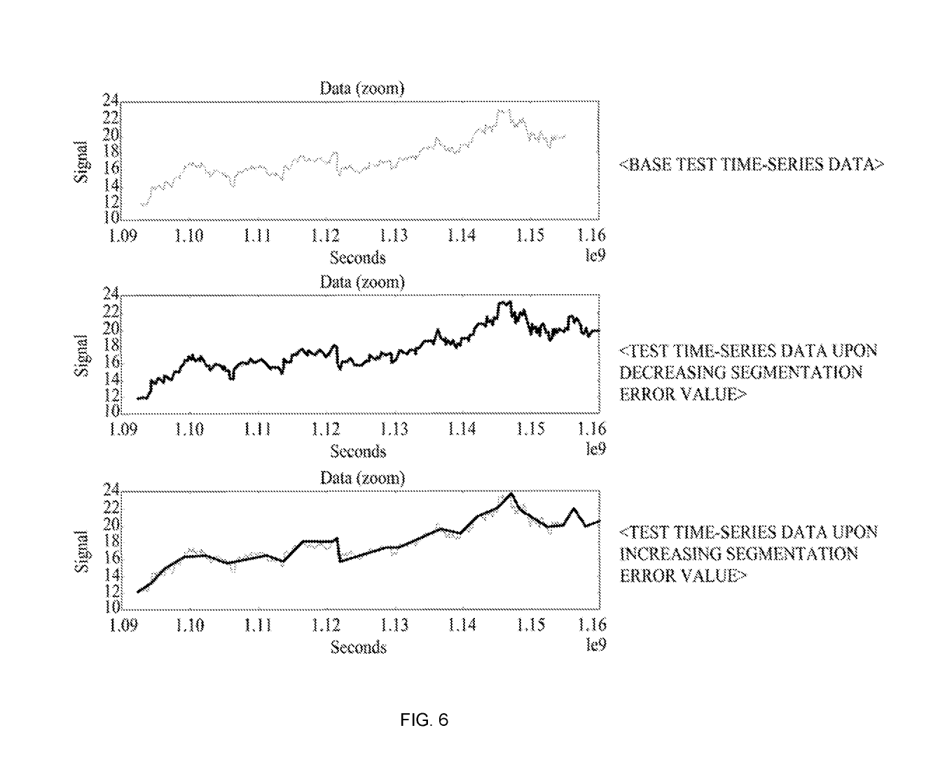

That is, as shown in FIG. 6, in general, the base time-series data or the base test time-series data may be displayed in a smooth curve form. The base time-series data or the base test time-series data may be converted into the time-series data including a segment of a straight line shape or the test series data by the segmentation.

At this time, as the error value of the segmentation becomes smaller, the time-series data or the test time-series data may be similar to the base time-series data or the base test time-series data. On the other hand, as the error value of the segmentation becomes larger, a difference between the time-series data or the test time-series data and the base time-series data or the base test time-series data becomes larger.

As described above, the processor 104 may automatically apply a plurality of segmentation error values to the base test time-series data without setting by user.

Accordingly, test time-series data for each segmentation error value is generated, and the processor 104 may automatically calculate the importance for each test segment forming each test time-series data.

The processor 104 may set the first test segment and the second test segment which have a great importance among the test segments to a first segment and a second segment.

At this time, the first test segment and the second test segment may be selected from among the test segments forming the test time-series data according to a single segmentation error value, but, alternatively, may be selected from among the test segments forming the test time-series data according to a plurality of segmentation error values.

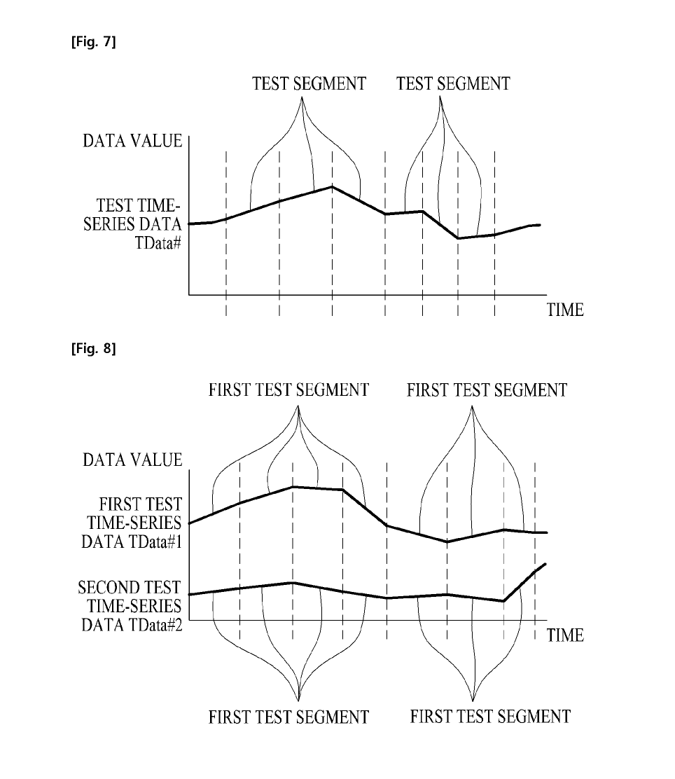

As shown in FIG. 7, when at least partial section of the test time-series data (TData#) is formed of test segment, the processor 104 may search the test search target time-series data (TData#_SER) through each test segment so that test matching segment may be derived.

At this time, the processor 104 may select the first test segment and the second test segment which have a high importance among a plurality of test segments as the first segment and the second segment respectively according to the derivation result.

In addition, as shown in FIGS. 4 and 5, the selection of the first segment and the second segment may also be selected from a plurality of first and second test segments.

That is, the processor 104 may derive the first test matching segment of the first test search target time-series data (#TData1_SER) which is matched to the first test segment of the first test time-series data (TData#1).

The processor 104 may select the first test setting section having a high importance among a plurality of first test segments as the first segment according to the derivation result of the first test matching segment.

In addition, the processor 104 may derive the second test matching segment of the second test search target time-series data (#TData2_SER) which is matched to the second test segment of the second test time-series data (TData#2).

The processor 104 may select the second test segment having a high importance among a plurality of second test segments as the second segment according to the derivation result of the second test matching segment.

At this time, the first and second test time-series data (TData#1, TData#2) may be the same as the first and second time-series data (Data#1, Data#2) respectively, or may be different time-series data.

In addition, the first and second test search target time-series data (Data#1_SER, Data#2_SER) may also be the same as the first and second search target time-series data (Data#1_SER, Data#2_SER) respectively, or may be different from each other.

That is, as shown in FIG. 8, when at least partial section of the first test time-series data (TData#1) and the second test time-series data (TData#2) includes the first test segment and the second test segment, the processor 104 may search the first test search target time-series data (TData#1_SER) and the second test search target time-series data (TData#2_SER) through the first test segment and the second test segment, thereby deriving the first test matching segment and the second test matching segment.

As described in the above, the data searching apparatus search according to an embodiment of the present disclosure may automatically derive the first segment and the second segment, and may derive the search target time-series data (Data#_SER) through the first segment and the second segment or may derive the matching segment from the first and second search target time-series data (Data#1 SER, Data#2_SER).

For example, the processor 104 may convert the base test time-series data into the test time-series data (TData#) formed of five hundreds test segments, and calculate the importance of each of the five hundreds test segments to automatically derive the first segment and the second. In addition, the processor may automatically derive the search target time-series data (Data#_SER) through the first and second segments, or derive the matching segment from the first and second search target time-series data (Data#1_SER, Data#2_SER).

Meanwhile, in FIG. 7, the processor 104 may derive the test matching segment while changing the permission similarity between the test segment and the test matching segment. The permission similarity may be a tolerance for determining a degree of congruence of the first test segment and the second test segment, and the test search target time-series data (TData#_SER) which can be considered as matching.

Since the importance is calculated while the permission similarity is changed, the permission similarity may affect the importance. Thus, the permission similarity of the test segment which is selected as the first segment and the second segment may be used in the process of searching the first matching segment and the second matching segment of the processor 104 described through FIG. 2 and FIG. 3.

In addition, in FIG. 8, the processor 104 may derive the first test matching segment and the second test matching segment while changing a first permission similarity between the first test segment and the first test matching segment, and a second permission similarity between the second test segment and the second test matching segment.

Similarly to the above description, the first permission similarity and the second permission similarity may affect the importance, and the first permission similarity of the first test segment selected as the first segment and the second segment and the second permission similarity of the second test segment may be used in the process of searching the first matching segment and the second matching segment of the processor 104 described through FIG. 4 and FIG. 5.

Next, the above mentioned importance is described with reference to the drawings.

In addition, in FIG. 7, the processor 104 may calculate importance through at least one of the number of times of derivation of deriving the test matching segment in the entire section of the test search target time-series data (TData#_SER), the sum of test matching segment section, the ratio of the number of times of derivation and the test matching segment section, the ratio of the sum of the test matching segment section and the entire section, and the derivation cycle of test matching segment. At this time, the derivation cycle may be one second, one minute, one hour, one day, one week, one month, one year, or the like, but it is not limited thereto.

That is, the importance of the test setting segment may increase as the number of times of generating the test matching segment or the period of generating the test matching segment is increased. Therefore, the increase of importance may mean that the possibility of assisting a specific test setting segment in the interpretation of test search target time-series data (#TData_SER) is increased.

Meanwhile, in FIG. 8, the processor 104 may calculate importance of a first test segment through at least one of the number of times of a first derivation of deriving the first test matching segment in the entire section of the first test search target time-series data, the sum of the first test matching segment section, the ratio of the number of times of the first derivation and the first test matching segment section, the ratio of the sum of the first test matching segment section and the entire section of the first test search target time-series data, and the derivation cycle of the first test matching segment section.

In addition, the processor 104 may calculate importance of a second test segment through at least one of the number of times of a second derivation of deriving the second test matching segment in the entire section of the second test search target time-series data, the sum of the second test matching segment section, the ratio of the number of times of the second derivation and the second test matching segment section, the ratio of the sum of the second test matching segment section and the entire section of the second test search target time-series data, and the derivation cycle of the second test matching segment.

At this time, since the derivation cycle is described above, an explanation thereof is omitted.

As described above, the processor 104 may select the test segment having a great importance among the test segments as the first segment and the second segment of FIG. 2 and FIG. 3.

In addition, the processor 104 may select the first test segment having a great importance among the first test segments as the first segment of FIG. 4 and FIG. 5. Similarly, the processor 104 may select the second test segment having a great importance among the second test segments as the second segment of FIG. 4 and FIG. 5.

Meanwhile, in FIG. 2 and FIG. 3, the processor 104 may calculate at least one of the ratio of the number of times of a derivation of deriving the first matching segment in the search target time-series data (Data#_SER) and the number of times of matching, and the ratio of the number of times of a derivation of deriving the second matching segment in the search target time-series data (Data#_SER) and the number of times of matching.

As described in the above, the number of times of the derivation of first matching segment may be counted whenever the first matching segment is matched to the first segment in the search target time-series data. Similarly, the number of times of the derivation of second matching segment may be counted whenever the second matching segment is matched to the second segment in the search target time-series data (Data#_SER).

Alternatively, the number of times of matching may be counted whenever the first matching segment and the second matching segment located within the set time (Tau) occur simultaneously.

When the ratio of the number of times of matching to the number of times of the derivation is high, it can be known that the correlation of the first segment and the second segment is high.

For example, if the first matching segment matched to the first segment and the second matching segment matched to the second pattern occur 100 times and 150 times respectively in the search target time-series data A and the search target time-series data B, the number of times of matching of the simultaneous occurrence of the first matching segment and the second matching segment located within the set time (Tau) in the search target time-series data A may be 70 times, and the number of times of matching of the simultaneous occurrence of the first matching segment and the second matching segment located within the set time (Tau) in the search target time-series data B may be 50 times.

The correlation of the first segment and the second segment may be greater in the search target time-series data B in comparison with the search target time-series data A.

Similarly, in FIG. 4 and FIG. 5, the processor 104 may calculate the ratio of the number of times of a derivation of deriving the first matching segment in the first search target time-series data (Data#1_SER) and the number of times of matching.

In addition, the processor 104 may calculate at least one of the ratio of the number of times of a derivation of deriving the second matching segment in the second search target time-series data (Data#2_SER) and the number of times of matching.

According to the operation to the processor 104, the degree of correlation of the first segment and the second segment which are located within the set time (Tau) in the first search target time-series data (Data#1_SER) and the second search target time-series data.

As shown in FIG. 2 and FIG. 3, the processor 104 may calculate at least one ratio for the search target time-series data while automatically increasing the set time (Tau). As explained in the above, the ratio for the search target time-series data may be at least one of the ratio of the number of times of a derivation of deriving the first matching segment in the search target time-series data (Data#_SER) and the number of times of matching, and the ratio of the number of times of a derivation of deriving the second matching segment in the search target time-series data (Data#_SER) and the number of times of matching.

The processor 104 may calculate the ratio by automatically changing the set time (Tau) not the set time (Tau) set by user. Thus, the set time (Tau) between the first segment and the second segment which have a high correlation may be derived automatically.

Similarly, as shown in FIG. 4 and FIG. 5, the processor 104 may calculate at least one ratio for the first search target time-series data (Data#1_SER) and the second search target time-series data (Data#2_SER) while automatically increasing the set time (Tau).

At this time, the at least one ratio may be at least one of the ratio of the number of times of a derivation of deriving the first matching segment in the first search target time-series data (Data#1_SER) and the number of times of matching, and the ratio of the number of times of a derivation of deriving the second matching segment in the second search target time-series data (Data#2_SER) and the number of times of matching.

Meanwhile, in FIG. 2 to FIG. 5, the processor 104 may assign the comment of a first user for the first segment and the second segment or a first segment section and a second segment section. The comment may be inputted by the first user to the data searching apparatus according to an embodiment of the present disclosure through a terminal or the input unit 118. The comment may also be stored in the memory 106 and read by the processor 104.

The terminal may be PC, laptop PC, tablet PC, Smartphone, or the like, but it is not limited thereto.

The comment may be the first segment and the second segment which are located within the set time (Tau) or may be the interpretation, analysis, or notes of the first user for the first segment section and the second segment section, but it is not limited thereto.

At this time, the processor 104 may assign a score of a second user for at least one of the first segment and the second segment, the first segment section and the second segment section, and the comment.

The second user may apply to the search target time-series data (Data#_SER) desired by the second user or the first and second search target time-series data (Data#1_SER, Data#2_SER) through the first segment and the second segment, or the first segment section and the second segment section, thereby confirming the utility of the first segment and the second segment, or the first segment section and the second segment section. In addition, the second user may determine whether the assigned comment is appropriate.

Accordingly, the second user may input a score for the utility or the appropriacy for comment via the terminal or the input unit 118, and the data searching apparatus according to an embodiment of the present disclosure may assign the score.

Meanwhile, the processor 104 may assign the comment of the first user for the first segment and the second segment or the first segment section and the second segment section, and may assign a score for the comment of the second user cited in the comment of the first user.

That is, the first user may input his/her own comment to the data searching apparatus according to an embodiment of the present disclosure, and the comment of the first user may cite the comment of other user.

The processor 104 may endow a code for every comment stored in a recording medium (RM) so as to recognize the cited comment, and the first user may insert the code of the cited comment into his/her own comment.

Since the appropriacy or the utility for comment may become high when the number of citations becomes high, the processor 104 may endow a score to the cited comment whenever the comment is cited.

The processor 104 may convert such a score into a price, and thus may accomplish the sale of the first user comment for a first pattern and a second pattern or a first setting section and a second setting section.

The data searching apparatus according to an embodiment of the present disclosure may derive the number of times of matching of the first segment and the second segment which are located within the set time, thereby calculating the correlation of different time-series data.

The data searching apparatus according to an embodiment of the present disclosure may automatically derive the correlation through the segmentation.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A data searching apparatus comprising:
a memory configured to store time-series data formed of a plurality of segments including a first segment and a second segment; and
a processor configured to read out the time-series data by accessing the memory,
wherein the processor derives a first matching segment of search target time-series data matched to the first segment, and
counts the number of times of matching when a second matching segment of the search target time-series data matched to the second segment is derived from the first matching segment within a set time.

2. A data searching apparatus comprising:
a memory configured to store a first time-series data formed of a plurality of segments including a first segment and a second time-series data formed of a plurality of segments including a second segment; and
a processor configured to read out the first time-series data and the second time-series data by accessing the memory,
wherein the processor derives a first matching segment of a first search target time-series data matched to the first segment, and counts the number of times of matching when a second matching segment of a second search target time-series data matched to the second segment is derived from the first matching segment within a set time.

3. The data searching apparatus of claim 1, wherein the processor derives test matching segment of test search target time-series data matched to test segment of test time-series data, and selects a first test segment and a second test segment which have a high importance among a plurality of the test segments as the first segment and the second segment respectively according to the derivation result.

4. The data searching apparatus of claim 2, wherein the processor derives a first test matching segment of a first test search target time-series data which is matched to a first test segment of a first test time-series data, selects a first test segment having a high importance among a plurality of the first test segments as the first segment according to the derivation result of the first test matching segment, derives a second test matching segment of a second test search target time-series data which is matched to a second test segment of a second test time-series data, and selects a second test segment having a high importance among a plurality of the second test segments as the second segment according to the derivation result of the second test matching segment.

5. The data searching apparatus of claim 3, wherein the processor derives the test matching segment while changing permission similarity between the test segment and the test matching segment.

6. The data searching apparatus of claim 4, wherein the processor derives the first test matching segment and the second test matching segment while changing a first permission similarity between the first test segment and the first test matching segment, and a second permission similarity between the second test segment and the second test matching segment.

7. The data searching apparatus of claim 3, wherein the processor calculates the importance through at least one of the number of times of derivation of deriving the test matching segment in an entire section of the test search target time-series data, a sum of the test matching segment section, a ratio of the number of times of derivation and the test matching segment section, a ratio of the sum of the test matching segment section and the entire section, and a derivation cycle of the test matching segment.

8. The data searching apparatus of claim 4, wherein the processor calculates the importance of the first test segment through at least one of the number of times of a first derivation of deriving the first test matching segment in an entire section of the first test search target time-series data, a sum of the first test matching segment section, a ratio of the number of times of the first derivation and the first test matching segment section, a ratio of the sum of the first test matching segment section and the entire section of the first test search target time-series data, and a derivation cycle of the first test matching segment, and calculates the importance of the second test segment through at least one of the number of times of a second derivation of deriving the second test matching segment in an entire section of the second test search target time-series data, a sum of the second test matching segment section, a ratio of the number of times of the second derivation and the second test matching segment section, a ratio of the sum of the second test matching segment section and the entire section of the second test search target time-series data, and a derivation cycle of the second test matching segment.

9. The data searching apparatus of claim 1, wherein the processor calculates at least one of a ratio of the number of times of a derivation of deriving the first matching segment in the search target time-series data and the number of times of matching, and a ratio of the number of times of a derivation of deriving the second matching segment in the search target time-series data and the number of times of matching.

10. The data searching apparatus of claim 2, wherein the processor calculates at least one of a ratio of the number of times of a derivation of deriving the first matching segment in the first search target time-series data and the number of times of matching, and a ratio of the number of times of a derivation of deriving the second matching segment in the second search target time-series data and the number of times of matching.

11. The data searching apparatus of claim 9, wherein the processor calculates at least one ratio for the search target time-series data while automatically increasing the set time.

12. The data searching apparatus of claim 10, wherein the processor calculates at least one ratio for the first search target time-series data and the second search target time-series data while automatically increasing the set time.

13. The data searching apparatus of claim 1, wherein the processor assigns comment of a first user for the first segment and the second segment or a first segment section and a second segment section, and assigns a score of a second user for at least one of the first segment and the second segment, the first segment section and the second segment section, and the comment.

14. The data searching apparatus of claim 2, wherein the processor assigns comment of a first user for the first segment and the second segment or a first segment section and a second segment section, and assigns a score of a second user for at least one of the first segment and the second segment, the first segment section and the second segment section, and the comment.

15. The data searching apparatus of claim 1, wherein the processor assigns comment of a first user for the first segment and the second segment or a first segment section and a second segment section, and assigns a score for comment of a second user cited in the comment of the first user.

16. The data searching apparatus of claim 2, wherein the processor assigns comment of a first user for the first segment and the second segment or a first segment section and a second segment section, and assigns a score for comment of a second user cited in the comment of the first user.
